(19) United States
(12) Patent Application Publication
(10) Pub. No.: US 2013/0264814 A1
(43) Pub. Date: Oct. 10, 2013

(54) SECURITY PAPER THAT IS DETECTABLE BY METAL DETECTORS

(71) Applicant: SAMSUNG ELECTRONICS CO., LTD., Suwon-si (KR)

(72) Inventors: Ae-kyung CHOI, Suwon-si (KR); Chang-woo JUNG, Seoul (KR); Taek-yong JUNG, Suwon-si (KR)

(73) Assignee: SAMSUNG ELECTRONICS CO., LTD., Suwon-si (KR)

(21) Appl. No.: 13/837,570

(22) Filed: Mar. 15, 2013

(30) Foreign Application Priority Data
Apr. 10, 2012 (KR) 10-2012-0037556

(51) Int. Cl. B42D 15/00

(52) U.S. Cl. CPC B42D 15/00
USPC 283/83

(57) ABSTRACT

A security paper that is detectable by a metal detector has a predetermined brightness. The security paper has a low content of volatile organic compounds (VOC). Also, the security paper retains an improved detect-ability for a period of time that is greater than a predetermined period of time. The security paper includes a detectable layer including metal-polymer composite particles and an aqueous binder resin.

### CROSS-REFERENCE TO RELATED APPLICATIONS

This application claims priority under 35 U.S.C. 119(a) from Korean Patent Application No. 10-2012-0037556, filed on Apr. 10, 2012, in the Korean Intellectual Property Office, the disclosure of which is incorporated herein in its entirety by reference.

### BACKGROUND OF THE INVENTION

1. Field of the Invention

The present general inventive concept relates to security paper, and in particular, to a security paper that is detectable by a metal detector.

2. Description of the Related Art

The increased significance in preventing unauthorized disclosure of information has led to the development of security technologies for blocking the unauthorized disclosure of various data recording media. However, in the case of a recording medium, such as paper, it is difficult to control unauthorized disclosure of the recording medium. Accordingly, research into security paper that enables the unauthorized disclosure of paper to be blocked is performed in various fields.

To efficiently manage documents, printer manufacturers have been providing a program for managing printing situations together with a printer since the 1990s. Also, recently, many businesses have adopted management of a printing system (MPS). Furthermore, printer manufacturers and printer users consider using security paper together with a MPS.

As a method of manufacturing security paper, various methods, for example, a method using a hidden line, a method using a fluorescent material, or a method using a metallic tag, are known. Also, the use of metal detectors, which are widely used in a security system, is taken into consideration with respect to manufacturing security paper that is detectable by a metal detector.

Metal detectors are used to detect the presence of a metallic material even when the metallic material is not in sight, by using electromagnetic induction and eddy current. When a magnetic field occurs in a coil in which an alternative current flows, an eddy current occurs in a metal due to the magnetic field. The eddy current that occurs in the metal causes a magnetic field, which is detected by metal detectors to confirm a presence of the metal. As is well known, metal detectors are used for various purposes, such as removing of mines, detecting of arms at airport security check points, archaeological digging, treasure hunting, geological prospecting, or detecting of impurities in food.

Various papers having a stack structure including a metal layer have been described. For example, KR 10-2008-0107977 (published on Dec. 11, 2008) describes a printing paper for security purposes, including first and second paper sheets having surfaces attached to each other by using an adhesive material and at least one detection tag interposed between the attached surfaces of the first and second paper sheets. Also, according to the disclosure of the above-described reference, the detection tag may include an amorphous soft alloy, a metal thin film may be further formed between the attached surfaces of the first and second paper sheets, and the first paper sheet or the second paper sheet may have a surface onto which metal is vacuum-deposited or transferred.

However, the laminating of many layers may be problematic. For example, manufacturing costs may be increased, curling of paper may occur during the laminating process, and excess volatile organic compounds (VOC) may be included in the paper due to an adhesive used during the laminating process.

VOC contained in paper may be released by heating during printing. The amount of VOC released during printing is restricted according to an international standard which has been set due to environmental issues. Accordingly, if VOC are released in excessive amounts from paper, it may bring about disadvantageous effects. In particular, when a laser printer is used, a temperature during a fixing process is, for example, from about 120° C. to about 200° C. Accordingly, a considerable amount of VOC may be released.

As described in Korean Patent No. 10-2008-0107977, when a metal tag is used, a black ink layer for shielding a tag may additionally be needed. When a paper sheet contains the black ink layer, the paper brightness may be lowered. The brightness is one of the important factors which determine a quality of the paper. When the paper brightness is lowered, a quality of an image printed on the paper is also lowered.

Metal powder may also provide security paper with a “detect-ability” for detection by metal detectors (hereinafter, briefly referred to as “detect-ability”). However, metal powder contained in security paper may oxidize over time. When the metal powder of the security paper oxidizes, the detect-ability of the security paper may decrease.

### SUMMARY OF THE INVENTION

The present general inventive concept provides a security paper that is detectable by a metal detector. The security paper may have excellent brightness characteristics. The security paper may have a low content of volatile organic compounds (VOC). Also, the security paper may retain an improved detect-ability for a long period of time.

Additional features and utilities of the present general inventive concept will be set forth in part in the description which follows and, in part, will be obvious from the description, or may be learned by practice of the general inventive concept.

Exemplary embodiments of the present general inventive concept, include a security paper including a substrate sheet, and a detectable layer that is attached to at least a portion of at least a surface of the substrate sheet, wherein the detectable layer includes metal-polymer composite particles and a water-soluble binder resin. A composition to form the detectable layer may include metal-polymer composite particles, a water-soluble binder resin, and water.

Exemplary embodiments of the present general inventive concept may also provide a security paper that is detectable by a metal detector, the security paper includes a substrate sheet and a detectable at least portion of a layer attached thereto, wherein the portion comprises polymer encapsulated metal particles. The at least portion of the detectable layer may further include a water-soluble binder resin.

Exemplary embodiments of the present general inventive concept may also provide a metal detectable security medium that includes a security medium and at least a partial coating, on the security medium, of polymer encapsulated metal particles.

### BRIEF DESCRIPTION OF T HE DRAWINGS

These and/or other features and utilities of the present general inventive concept will become apparent and more readily appreciated from the following description of the embodiments, taken in conjunction with the accompanying drawings of which:

FIG. 1 is an illustration of an embodiment of a security paper having a reduced portion of a detectable layer on a substrate sheet in accordance with the present general inventive concept;

FIG. 2 is an illustration of an embodiment of a security paper having an increased portion of a detectable layer on a substrate sheet in accordance with the present general inventive concept;

FIG. 3 is an illustration of an embodiment of a security paper having an irregular portion of a detectable layer on a substrate sheet in accordance with the present general inventive concept;

FIG. 4 is an illustration of an embodiment of a security paper having a full-size detectable layer on a substrate sheet in accordance with the present general inventive concept;

FIG. 5 is an illustration of an embodiment of a security paper having an undercoating layer between the detectable layer and the substrate sheet in accordance with the present general inventive concept;

FIG. 6 is an illustration of an embodiment of a security paper having a portion of a detectable layer between two substrate sheets in accordance with the present general inventive concept; and

FIGS. 7A, 7B, and 7C are illustrations of embodiments of a metal detectable security medium that includes a security medium and at least a partial coating, on the security medium, of polymer encapsulated metal particles in accordance with the present general inventive concept.

### DETAILED DESCRIPTION OF THE PREFERRED EMBODIMENTS

The present general inventive concept will now be described more fully with reference to the accompanying drawings, in which exemplary embodiments of the present general inventive concept are shown. Expressions such as “at least one of,” when preceding a list of elements, modify the entire list of elements and do not modify the individual elements of the list.

Reference will now be made in detail to the exemplary embodiments of the present general inventive concept. The embodiments are described below in order to explain the present general inventive concept.

A security paper according to an embodiment of the present general inventive concept includes: a substrate sheet, and a detectable layer that is attached to at least a portion of at least a surface of the substrate sheet, wherein the detectable layer includes metal-polymer composite particles and a water-soluble binder resin.

The detectable layer of the security paper may include a plurality of metal-polymer composite particles and a water-soluble binder resin.

The metal-polymer composite particles may be metal particles surrounded by a polymer capsule.

The metal particles may be any one of the metals that are detectable by a metal detector. Examples of the metal particles may include particles of iron, cobalt, nickel, manganese, silver, copper, zirconium, aluminum, or a combination thereof. For example, the metal particles may include a ferromagnetic metal. Examples of the ferromagnetic metal may include iron, cobalt, nickel, manganese, or a combination thereof. Due to the use of ferromagnetic metal particles, detect-ability may be obtained with a number of metal particles that is less than a predetermined number of particles. A particle size of the metal particles may not be limited. However, when the particle size of the metal particles is less than a predetermined particle size, the detect-ability may be lowered, and when the particle size of the metal particles is greater than a predetermined particle size, dispersibility of the metal particles in a composition for forming the detectable layer may be lowered. For example, an average particle size of the metal particles may be in a range of about 0.1 μm to about 100 μm.

The polymer capsule may be any polymer that may form a film surrounding the metal particles. The polymer capsule may be, for example, a hydrophilic polymer. When the polymer capsule is hydrophilic, an aqueous composition to form the detectable layer may be readily prepared. Examples of the polymer capsule may include starch, a styrene-butadiene-based resin, an acryl-based resin, or a combination thereof.

An example of a method of preparing the metal-polymer composite particles is described below. A fatty acid (for example, a palmitic acid) is added to a mixture of metal powder and an aqueous solution of starch. Then, an alkali is added to the resultant mixture to control a pH thereof to prepare an alkali solution. An acid is added to the alkali mixed solution to neutralize the mixture. Then, an acid is added thereto to control a pH thereof to prepare an acidic solution, thereby causing precipitation. The precipitate is made of metal-polymer composite particles.

In the course of the manufacturing process described above, flocculation may occur between monoglyceride of the fatty acid and amylopectin of the starch, and thus, a water-insoluble protective film is formed on a hydrophilic surface of the polymer capsule (that is, the starch capsule) of the precipitate (the metal-polymer composite particles). Thus, the starch capsule is not water-soluble and retains its hydrophilic property. As the fatty acid, in addition to the palmitic acid, any one of various fatty acids that may induce flocculation with amylopectin may be utilized herein.

Starch is a polymer that is produced by condensation of glucose. Starch is a mixture of amylose and amylopectin. Each of the amylose and the amylopectin is a polymer formed by condensation of glucose. According to which part of glucose takes part in a condensation reaction, a formed molecule may vary. Amylose and amylopectin are examples thereof. A ratio of amylose to amylopectin may be roughly constant regardless of the kind of starch. Typically, starch may include about 20 to about 25 wt % of amylose and about 75 to about 80 wt % of amylopectin. Starch may be, for example, sweet potato starch, potato starch, wheat starch, corn starch, or a mixture thereof. Among these starches, the cheapest corn starch is widely used. Corn starch is used as, in a paper manufacturing process, a retention aid, a dry strength agent, and an internal/surface sizing agent. Corn starch also has excellent compatibility with a surface of a paper sheet. Corn starch is also used as a food additive, and thus, is regarded as an environmentally friendly material.

Metal-polymer composite particles having a hydrophilic polymer capsule may be very easily dispersed in an aqueous medium. Correspondingly, without a dispersion process using a dispersion device, such as a ball mill, a sand mill, or a dynomill, and a dispersant, an aqueous composition for forming the detectable layer may be very easily formed. Accordingly, manufacturing costs for the aqueous composition for forming the detectable layer may be substantially reduced.

When a weight ratio of metal particles to the polymer capsule in the metal-polymer composite particles is less than a predetermined weight ratio, encapsulation may be difficult to achieve. Hence, dispersion in the manufacturing process of a coating solution may not be readily achieved, and thus, a coating ability may decrease. When the weight ratio of metal particles to the polymer capsule is greater than a predetermined weight ratio, a detect-ability may decrease. For example, a weight ratio of metal particles to the polymer capsule in the metal-polymer composite particles may be in a range of about 5:95 to about 95:5.

When an average particle size of the metal-polymer composite particles is less than a predetermined particle size, manufacturing costs may be increased, and when the average particle size of the metal-polymer composite particles is greater than a predetermined particle size, dispersibility may decrease, thereby causing poor coating ability. An average particle size of the metal-polymer composite particles may be, for example, in a range of about 0.1 μm to about 100 μm. The average particle size of metal-polymer composite particles may be controlled by using, for example, an average particle size of metal particles and a weight ratio of metal particles to the polymer capsule. That is, the greater the average particle size the metal particles have, the greater the average particle size the metal-polymer composite particles have. The greater the weight ratio of metal particles to the polymer capsule, the greater the average particle size the metal-polymer composite particles have.

The water-soluble binder resin may be, for example, polyvinyl alcohol, polyvinylpyrrolidone, cellulose, polyacryl, polyester, a derivative thereof, or a combination thereof.

When the detectable layer has a reduced content of metal-polymer composite particles, the detect-ability may be reduced. On the other hand, when the detectable layer has a content of metal-polymer composite particles that is greater than a predetermined content, a detect-ability of security paper may be increased. In this case, however, material costs for the preparation of security paper (that is, material costs of metal particles) may be increased. For example, an amount of metal-polymer composite particles in the detectable layer may be in a range of about 1 wt % to about 50 wt % based on 100 wt % of the total weight of the detectable layer.

When the thickness of the detectable layer increases, a detect-ability of the security paper may increase. However, when the detectable layer is greater than a predetermined thickness and the security paper is used in an inkjet printer, a decrease in ink adsorption force and a decrease in ink drying speed may occur. When security paper is used in a laser printer, a decrease in fixability of the toner and a decrease in transferring efficiency of the toner may occur. Also, the greater the thickness of the detectable layer, the greater the manufacturing costs of the security paper. When a thickness of the detectable layer is less than a predetermined thickness, the detect-ability may decrease. For example, the thickness of the detectable layer may be in a range of about 1 μm to about 100 μm.

The detectable layer according to the present disclosure may have the same level of brightness as a typical printing paper. Unlike KR Patent Publication No. 10-2008-0107977, according to the exemplary embodiments of the present general inventive concept, a filler, such as carbon black, is not used to shield a metal tag. Accordingly, the level of the brightness may not decrease. The brightness of the paper is a critical factor in determining a quality of an image, and when the level of the brightness decreases, the chroma or the brightness of a printed image may decrease.

The substrate sheet of the security paper may be, for example, paper or a resin film. The paper may be, for example, a paper that is coated with a resin or a paper that is not coated with a resin. The paper that is not coated with a resin may be, for example, wood-free paper or paper having a predetermined thickness. The paper that is coated with a resin may be, for example, art paper or coated paper, cast coated paper, or resin coated paper. The resin film may be, for example, polyethylene terephthalate, polycarbonate, or cellulose acetate. A thickness of the substrate sheet may not be particularly limited.

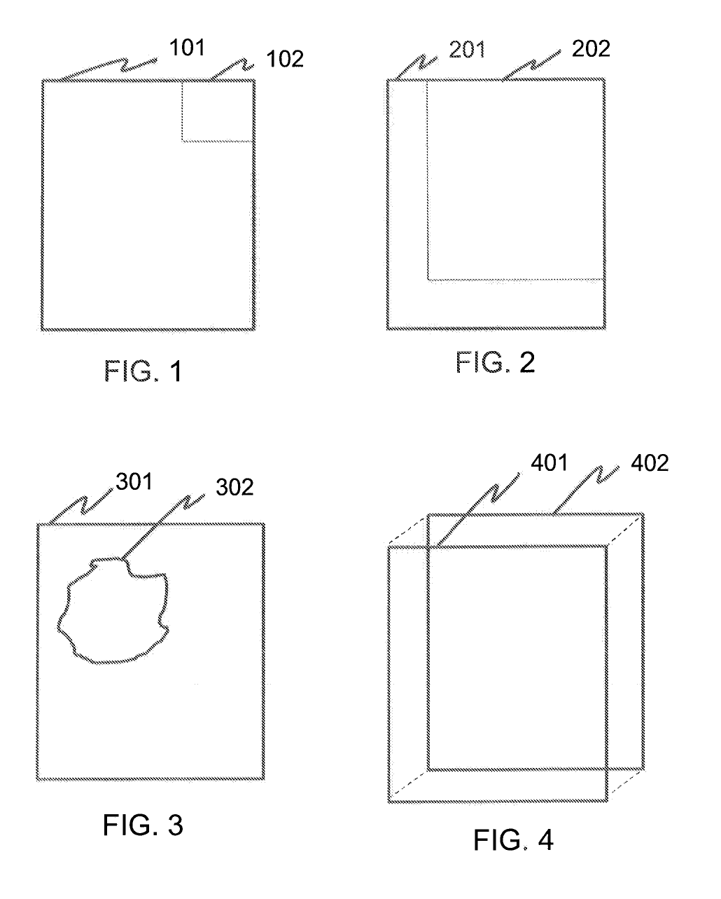

Referring to FIGS. 1-3, FIG. 1 is an illustration of an embodiment of a security paper having a reduced portion of a detectable layer on a substrate sheet in accordance with the present general inventive concept. FIG. 2 is an illustration of an embodiment of a security paper having an increased portion of a detectable layer on a substrate sheet in accordance with the present general inventive concept. FIG. 3 is an illustration of an embodiment of a security paper having an irregular portion of a detectable layer on a substrate sheet in accordance with the present general inventive concept. Thus, as illustrated in FIGS. 1-3, the detectable layer 102, 202, and 302, or a portion thereof, may be attached to at least a portion of at least a surface of the substrate sheet 101, 201, and 301, respectively.

FIG. 4 is an illustration of an embodiment of a security paper having a full-size detectable layer on a substrate sheet in accordance with the present general inventive concept. Thus, as illustrated in FIG. 4, the detectable layer 401 may be coated completely on a surface of the substrate sheet 402. Alternatively, the detectable layer 102, 202, and 302 may be coated on a portion of a surface of the substrate sheet 101, 201, and 301, respectively. A region for the detectable layer may be appropriately selected according to a detect-ability of the metal detector. Alternatively, to increase the detect-ability of security paper, the detectable layer may be attached to a portion of each of both surfaces of the substrate sheet. In this case, the detectable layer may be attached to a surface of the substrate sheet and the other surface of the substrate sheet, or the detectable layer may be attached to a surface of the substrate sheet and a portion of the other surface of the substrate sheet, or the detectable layer may be attached to a portion of a surface of the substrate sheet and the other surface of the substrate sheet, or the detectable layer may be attached to a portion of a surface of the substrate sheet and a portion of the other surface of the substrate sheet. When the detectable layer is located on a portion of any one of the surfaces of the substrate sheet, the location of the detectable layer is not limited. Accordingly, the detectable layer may be located in either a printing area or a non-printing area, or in both a printing area and a non-printing area.

The shape and the area of the detectable layer are not particularly limited. For example, even when three detectable layers, each having a bar shape having a width of 1 mm extending from an upper portion to a lower portion of security paper, are formed on a surface of security paper, excellent detect-ability may be obtained.

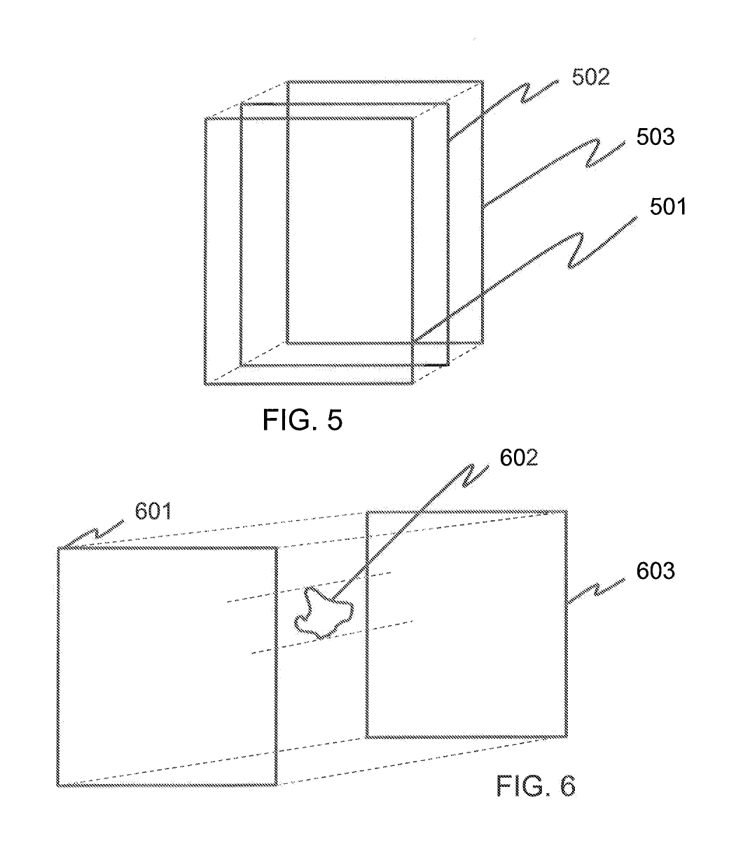

FIG. 5 is an illustration of an embodiment of a security paper having an undercoating layer between the detectable layer and the substrate sheet in accordance with the present general inventive concept. As illustrated in FIG. 5, the security paper may include an under-coating layer 502 between a substrate sheet 501 and a detectable layer 503. The under-coating layer 502 may enhance an adhesion force between the substrate sheet 501 and the detectable layer 503. When the adhesion force is weak, the substrate sheet 501 and the detectable layer 503 may be exfoliated from each other during printing using a printer. The under-coating layer 502 is useful when the substrate sheet 501 is a resin film. The under-coating layer 502 is more useful when the substrate sheet 501 is a hydrophobic resin film. FIG. 6 is an illustration of an embodiment of a security paper having a portion of a detectable layer between two substrate sheets in accordance with the present general inventive concept. As illustrated in FIG. 6, the undercoating layer 602 between the detectable layer 601 and the substrate sheet 603 may cover a portion of the detectable layer 601.

The under-coating layer may be, for example, an adhesive layer. Alternatively, to minimize the VOC content in the security paper, the under-coating layer may be formed of a water-soluble resin. A water-soluble resin used to form the under-coating layer may be, for example, a polyol-based resin, an acryl-based resin, a poly urethane-based resin, a vinyl resin, or a combination thereof.

The under-coating layer may further include an inorganic filler. The inorganic filler may be, for example, calcium carbonate, titanium dioxide, clay, talc, silica, or alumina.

When the under-coating layer is thicker than a predetermined thickness, in the case of an ink-jet printer, an ink adsorption force may be reduced, and in the case of a laser printer, fixability may be lowered. When the thickness of the under-coating layer is thicker than a predetermined thickness, the increase in the adhesion force between the substrate sheet and the detectable layer may be negligible. For example, a thickness of the under-coating layer may be in a range of about 0.1 μm to about 5 μm.

The under-coating layer may be formed to overlap where at least the detectable layer is formed, for example.

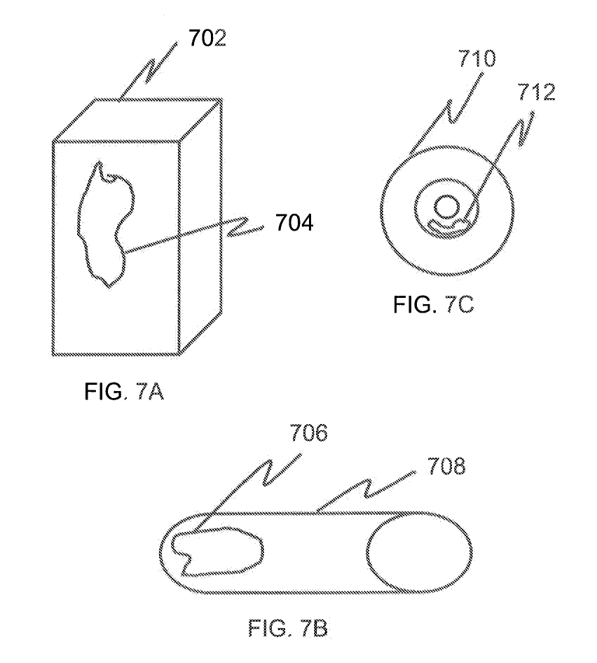

FIGS. 7A, 7B and 7C are illustrations of embodiments of a metal detectable security medium that includes a security medium and at least a partial coating, on the security medium, of polymer encapsulated metal particles according to exemplary embodiments of the present general inventive concept. That is, for example, the metal detectable security medium 702 may have a rectangular prism shape with at least a partial coating 704, on the security medium 702, of polymer encapsulated metal particles. Alternatively, the metal detectable security medium 708 may have a cylindrical shape with at least a partial coating 706 on the security medium 708, of polymer encapsulated metal particles. For example, the metal detectable security medium may be a data storage device. In another embodiment, the metal detectable security medium 710 may have a circular shape with at least a partial coating 712, on the security medium 710, of polymer encapsulated metal particles. In each of FIGS. 7A-7C, the location of the polymer encapsulated metal particles is selected so as not to interfere with utilization of the security medium.

The present general inventive concept includes a composition to form the detectable layer, the composition including metal-polymer composite particles, a water-soluble binder resin, and water.

Water functions as a solvent for the water-soluble binder resin, and as a medium for dispersing metal-polymer composite particles. Due to the use of water and the water-soluble binder resin, the VOC content in the detectable layer of the security paper may be minimized.

An amount of water in the composition may be appropriately determined in such a way that the composition retains a viscosity that is appropriate for a coating method used in coating the composition on a substrate sheet. When the water content in the composition is less than a predetermined water content, dispersibility or coating properties may be reduced, and when the water content in the composition is greater than a predetermined water content, the thickness of the detectable layer may not be increased. For example, the water content in the composition may be in a range of about 100 parts by weight to about 1000 parts by weight based on 100 parts by weight of all of the components that form the detectable layer. For example, a viscosity of the composition may be in a range of about 100 cP to about 5000 cP.

When metal-polymer composite particles include a hydrophilic polymer capsule, due to high compatibility between metal-polymer composite particles and water, the composition may not include a dispersing agent for metal-polymer composite particles.

To effectively disperse metal-polymer composite particles, the composition may further include a dispersing agent. The dispersing agent may be, for example, polysiloxane, polycarboxylate, sodium polyphosphate, or a combination thereof. An amount of the dispersing agent may be, for example, in a range of about 0.5 parts by weight to about 10 parts by weight, based on 100 parts by weight of the metal powder.

Another aspect of the present general inventive concept provides a method of manufacturing security paper, the method including coating the composition according to the present disclosure on at least a portion of at least a surface of a substrate sheet, and drying the coated composition.

The substrate sheet may be used in a form of, for example, a sheet or roll.

The coating may be performed by using various coating methods, for example, spraying, painting, or printing. For example, the coating may be performed by using a blade coater, a bar coater, a gravure coater, an air-knife coater, a roll-to-roll coater, or the like.

The drying may be performed by using a typical drying method, for example, natural drying, freeze drying, or hot drying.

According to another embodiment of the present general inventive concept, the method may further include, prior to the coating of the composition, forming an under-coating layer on the substrate sheet.

The forming of the under-coating layer may be performed by coating a composition of forming an under-coating layer which includes an aqueous solution of a water-soluble resin on at least a portion of at least a surface of the substrate sheet. Drying of the coated composition may be performed together with the drying of the composition of forming the detectable layer. Alternatively, the forming of the under-coating layer may be performed by coating the under-coating layer forming composition including an aqueous solution of a water-soluble resin on at least a portion of at least a surface of the substrate sheet, followed by drying the coated composition. The coating and drying of the under-coating layer forming composition may be performed by using the same methods as described above with reference to the composition of forming the detectable layer. A water content in the under-coating layer forming composition may be appropriately selected to obtain a viscosity that is appropriate for a selected coating method. When the water content in the under-coating layer forming composition is less than a predetermined water content, coating properties may decrease, and when the water content in the under-coating layer forming composition is greater than a predetermined water content, a drying time may be increased. For example, the water content in the under-coating layer forming composition may be in a range of about 500 parts by weight to about 10000 parts by weight based on 100 parts by weight of the water-soluble binder resin. For example, a viscosity of the under-coating layer forming composition may be in a range of about 10 cP to about 1000 cP.

### EXAMPLE

### Preparation Example 1

### Preparation of Iron-starch Composite Powder

200 g of 5 wt % aqueous solution of corn starch (Daesang Company MTB #1200) and 10 g of iron powder (Chang Seong Company CFE-04, an average particle size of 4 μm to 6 μm) were stirred at a temperature of 90° C. for 60 minutes. 2 g of palmitic acid (Daemyong Chemical Company Palmitic acid) was added to the obtained mixture. A pH of the resultant mixture was adjusted to 11 by using 0.1 M KOH aqueous solution. Then, the resultant mixture was further stirred for 10 minutes. Then, the mixture was neutralized by using 0.01 M HCl aqueous solution. A pH of the neutralized mixture was adjusted to 5 by using 2 M HCl aqueous solution while slowly stirring at a rate of 500 rpm, thereby causing precipitation. The precipitate was filtered and dried at a temperature of 100° C. The obtained precipitate will be referred to as an iron-starch composite powder of Preparation Example 1.

### Preparation Example 2

### Preparation of Cobalt-Starch Composite Powder

A cobalt-starch composite powder of Preparation Example 2 was prepared in the same manner as in Preparation Example 1, except that cobalt powder (Chang Seong Company, NCO-600, 1.1 μm to 1.7 μm of average particle size) was used instead of iron powder.

### Preparation Example 3

### Preparation of Zirconium-Starch Composite Powder

A zirconium-starch composite powder of Preparation Example 3 was prepared in the same manner as in Preparation Example 1, except that zirconium powder (AMS Company 3Y-TZP, 0.25 μm of average particle size) was used instead of iron powder.

### Example 1

### Preparation of Composition for Forming Detectable Layer

A composition was prepared by mixing 10 parts by weight of polyvinyl alcohol (product of OCI Company-Korea, P-224), 5 parts by weight of the iron-starch composite powder of Preparation Example 1, and 85 parts by weight of water by using a ball mill.

### Example 2

### Preparation of Composition for Forming Detectable Layer

A composition was prepared by mixing 15 parts by weight of hydroxypropyl methylcellulose (product of Samsung Fine Chemicals-Korea, Anycoat-C), 5 parts by weight of the cobalt-starch composite powder of Preparation Example 2, and 80 parts by weight of water by using a ball mill.

### Example 3

### Preparation of Composition for Forming Detectable Layer

A composition was prepared by mixing 10 parts by weight of polyvinyl alcohol (product of OCI Company-Korea, P-224), 5 parts by weight of the zirconium-starch composite powder of Preparation Example 3, and 85 parts by weight of water by using a ball mill.

### Example 4

### Preparation of Security Paper

The composition prepared according to Example 1 was coated completely on a surface. of a sheet of wood-free paper having a size 80 g/m² manufactured by Hansol Paper Company by using a bar coater. The coated sheet was dried at a temperature of 100° C. for 1 minute. A weight of the prepared security paper was 90 g/m², and a weight and a thickness of the formed detectable layer were 10 g/m² and 10 μm, respectively.

### Example 5

### Preparation of Security Paper

The composition prepared according to Example 2 was coated completely on the surface of a sheet of wood-free paper having a size 80 g/m² manufactured by Hansol Paper Company by using a bar coater. The coated sheet was dried at a temperature of 100° C. for 1 minute. A weight of the prepared security paper was 90 g/m², and a weight and a thickness of the formed detectable layer were 10 g/m² and 10 μm, respectively.

### Example 6

### Preparation of Security Paper

The composition prepared according to Example 3 was coated completely on the surface of a sheet of wood-free paper having a size 80 g/m² manufactured by Hansol Paper Company by using a bar coater. The coated sheet was dried at a temperature of 100° C. for 1 minute. A weight of the prepared security paper was 90 g/m², and a weight and a thickness of the formed detectable layer were 10 g/m² and 10 μm, respectively.

### Example 7

### Preparation of Security Paper

Security paper was prepared in the same manner as in Example 4, except that 107 μm PET(SH62) manufactured by SKC Company was used as a substrate sheet. A thickness of the formed detectable layer of the security paper was 10 μm.

### Comparative Example 1

### Preparation of Security Paper

Security paper was prepared in the same manner as in Example 4, except that a weight of the formed detectable layer was 0.5 g/m² after drying. A thickness of the detectable layer of the security paper was 0.5 μm.

### Comparative Example 2

### Preparation of Security Paper

Security paper was prepared in the same manner as in Example 4, except that a weight of a formed detectable layer was 110 g/m² after drying. A thickness of the detectable layer of the security paper was 110 μm.

### Comparative Example 3

### Preparation of Commercially Available Security Paper

Security paper (KR 10-2008-0108063, KR 10-2008-0107977) manufactured by Koreit Company, including a cobalt-based metal chip disposed between two sheets of paper, was used.

### Comparative Example 4

### Use of Un-Encapsulated Metal Powder

Preparation of a composition for forming a detectable layer: 10 parts by weight of polyvinyl alcohol (OCI Company-Korea, P-224), 5.0 parts by weight of iron powder (Chang Seong Company, CFE-04, average particle size of 4 μm to 6 μm), and 85.0 parts by weight of water were mixed by using a ball mill to prepare a composition for forming a detectable layer. The same manner as used in Example 4 was used to manufacture security paper, except that a weight of the detectable layer after the security paper was manufactured and dried, was adjusted to be 10 g/m². A thickness of a detectable layer of the security paper was 10 μm.

### <Evaluation Results>

The brightness, the optical density of the printed images, the ink adsorption force, the toner fixability, a TVOC release amount during printing, and a metal detector detectability of the security papers manufactured according to Examples 4 to 7 and Comparative Examples 1 to 4 were evaluated.

Brightness: the brightness of security paper was measured 10 times by using a colorimeter (USA “McBeth” Company “SpectroEye”) and an average thereof was used. The higher the brightness, the better.

Optical density of printed images: a yellow block image was printed on security paper by using a CLP-315 printer manufactured by Samsung Electronics Co., Ltd of Korea, and then an optical density of a yellow block image was measured by using a colorimeter (USA “McBeth” Company “SpectroEye”). The higher the value, the more distinctive the image.

Ink adsorption force: a black block image was printed on security paper by using a Japan EPSON Company stylus 915 inkjet printer. 30 seconds after the printing, the black block image was scrubbed three times by using a pendulum having a weight of 100 g, and then, a bleeding level of the black block image was measured based on a 5-point method. The lower the bleeding level, the greater the ink adsorption force.

Toner fixability: a black block image was printed on security paper by using a CLP-315 color laser printer manufactured by Samsung Electronics Co., Ltd of Korea, and then, first optical density was measured by using a SpectroEye measuring device of McBeth Company-USA. 60 seconds after, a 3M tape was attached to a black block image, then a pendulum having a weight of 500 g was scrubbed thereon ten times, and then, the tape was removed and a second optical density of the black block image was measured. A ratio of the first optical density to the second optical density is a residual rate. The higher the residual rate, the higher the toner fixability.

TVOC release amount during printing: the TVOC release amount was measured according to a guideline “Blue Angel” presented by a German material test research center (BAM) (printer: a mono laser printer SCX-6545N manufactured by Samsung Electronics Co., Ltd. of Korea, a test method: RAL-UZ 122).

Metal detector detect-ability: whether security paper is detectable by a metal detector (USA Dokscom Company AD-2600S) was confirmed. The test results were evaluated as “detection” or “non-detection.” A distance between the metal detector and the security paper was 5 cm.

Evaluation results obtained by using the security papers of Examples 4 to 7 and Comparative Examples 1 to4 are shown in Table 1.

TABLE 1

| | | Printed | Ink | Toner | | |
|---|---|---|---|---|---|---|
| | Bright- | image | absorp- | fix- | | |
| | ness | optical | tion | ability | TVOC | Detect- |
| | (%) | density | force | (%) | (mg/h) | ability |
| Example 4 | 91 | 1.25 | 1 | 94 | 8 | Detection |
| Example 5 | 89 | 1.21 | 1 | 95 | 8 | Detection |
| Example 6 | 91 | 1.23 | 1 | 94 | 11 | Detection |
| Example 7 | 91 | 1.27 | 2 | 93 | 9 | Detection |
| Comparative | 90 | 1.23 | 1 | 92 | 8 | Non- |
| Example 1 | | | | | | detection |
| Comparative | 89 | 1.22 | 3 | 81 | 11 | Detection |
| Example 2 | | | | | | |
| Comparative | 80 | 1.05 | 1 | 85 | 21 | Detection |
| Example 3 | | | | | | |
| Comparative | 50 | 0.90 | 2 | 80 | 12 | Detection |
| Example 4 | | | | | | |

The security paper of Examples 4 to 7 had a brightness of 89% to 91% and the security paper of Comparative Example 3 had a brightness of 80%. That is, the security paper of Examples 4 to 7 had a brightness that is 10% greater than that of the security paper of Comparative Example 3.

Images printed on the security paper of Examples 4 to 7 had an optical density of 1.21 to 1.27, and an image printed on the security paper of Comparative Example 3 had an optical density of 1.05. That is, images printed on the security paper of Examples 4 to 7 had an optical density that is 15% greater than that of an image printed on the security paper of Comparative Example 3.

The security paper of Examples 4 to 7 had a toner fixability of 89% to 95% and the security paper of Comparative Example 3 had a toner fixability of 85%. That is, the security paper of Examples 4 to 7 had a toner fixability that is 5% greater than that of the security paper of Comparative Example 3.

The security paper of Examples 4 to 7 had a TVOC release amount of 8 to 11 mg/h and the security paper of Comparative Example 3 had a TVOC release amount of 21 mg/h. That is, the security paper of Examples 4 to 7 had a TVOC release amount that is 52% less than that of the security paper of Comparative Example 3.

Like Comparative Example 1, when a detectable layer is thas less than a predetermined thickness, a detect-ability may decrease, and like Comparative Example 2, when a thickness of a detectable layer is greater than a predetermined thickness, a detect-ability may be increased, but the ink adsorption force and the toner fixability are decreased.

Like Comparative Example 4, when a metal powder is not encapsulated, a detect-ability may be excellent. In this case, however, the color of the metal used is exposed, and thus, the brightness of the security paper may decrease, and a printing optical density may also be decreased. Also, the ink adsorption force and the toner fixability may be lower than those of the security paper of Examples 4 to 7.

As described above, the security paper of Examples 4 to 7 has improved detectability with respect to a metal detector as well as improved qualities as a printing paper.

A security paper according to an embodiment of the present general inventive concept may be detectable by a metal detector. The security paper may have predetermined brightness characteristics. Accordingly, an image printed on the security paper may have a high quality. The security paper may have a low content of volatile organic compounds (VOC). According to the present disclosure, metal-polymer composite particles refer to metal particles surrounded by a polymer capsule. In other words, regarding metal-polymer composite particles, metal particles are coated with a polymer. The polymer capsule coated on surfaces of metal particles may prevent a contact between the metal particles and oxygen to prevent oxidation of the metal particles. Accordingly, in regard to the security paper according to an embodiment of the present general inventive concept, a decrease in detect-ability caused by oxidation of metal powder may not occur. Also, in the case of a composition including un-coated metal powder, coating thereof is difficult. However, metal-polymer composite particles used in the present disclosure may facilitate a composition of forming a detectable layer to be coated on a sheet of paper.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A security paper that is detectable by a metal detector, the security paper comprising:
a substrate sheet; and
a detectable layer attached to at least a portion of at least a surface of the substrate sheet, wherein the detectable layer comprises metal-polymer composite particles and a water-soluble binder resin, and wherein metal-polymer composite particles comprise metal particles surrounded by a polymer capsule.

2. The security paper of claim 1, wherein the metal particles of the metal-polymer composite particles are selected from the group consisting of: iron, cobalt, nickel, manganese, silver, copper, zirconium, aluminum, and a combination thereof.

3. The security paper of claim 1, wherein the metal particles of the metal-polymer composite particles include ferromagnetic metal.

4. The security paper of claim 3, wherein the metal particles of the metal-polymer composite particles are selected from the group consisting of: iron, cobalt, nickel, manganese, and a combination thereof.

5. The security paper of claim 1, wherein the polymer capsule of the metal-polymer composite particles is starch.

6. The security paper of claim 1, wherein the polymer capsule of the metal-polymer composite particles is a styrene-butadiene-based resin or an acryl-based resin.

7. The security paper of claim 1, wherein an average particle diameter of the metal particles of the metal-polymer composite particles is in a range of about 0.1 μm to about 100 μm.

8. The security paper of claim 1, wherein a weight ratio of the metal particles to the polymer capsule in the metal-polymer composite particles is in a range of about 5:95 to about 95:5.

9. The security paper of claim 1, wherein an average particle diameter of the metal-polymer composite particles is in a range of about 0.1 μm to about 100 μm.

10. The security paper of claim 1, wherein the water-soluble binder resin is selected from the group consisting of: polyvinyl alcohol, polyvinylpyrrolidone, cellulose, polyacryl, polyester, a derivative thereof, and a combination thereof.

11. The security paper of claim 1, wherein an amount of the metal-polymer composite particles in the detectable layer is in a range of about 1 wt % to about 50 wt % based on 100 wt % of the total weight of the detectable layer.

12. The security paper of claim 1, wherein a thickness of the detectable layer is in a range of about 1 μm to about 100 μm.

13. The security paper of claim 1, wherein the substrate sheet is a paper or a resin film.

14. The security paper of claim 1, wherein the substrate sheet is selected from the group consisting of: a wood-free paper, a paper of reduced thickness, an art paper, a cast coated paper, and a resin coated paper.

15. The security paper of claim 1, wherein the substrate sheet is selected from the group consisting of: polyethylene terephthalate, polycarbonate, cellulose acetate, polyethylene, polypropylene, and polyimine.

16. The security paper of claim 1, further comprising an under-coating layer interposed between the substrate sheet and the detectable layer.

17. The security paper of claim 16, wherein the under-coating layer is selected from the group consisting of: a polyol-based resin, an acryl-based resin, a poly urethane-based resin, a vinyl-based resin, and a combination thereof.

18. A composition to form the detectable layer of claim 1, the composition comprising: metal-polymer composite particles, a water-soluble binder resin, and water.

19. The composition of claim 18, wherein the composition lacks a dispersing agent.

20. A security paper that is detectable by a metal detector, the security paper comprising:
a substrate sheet; and
a detectable at least portion of a layer attached thereto, wherein the portion comprises polymer encapsulated metal particles.

21. The security paper of claim 20, wherein the at least portion of the detectable layer further includes a water-soluble binder resin.

22. A metal detectable security medium comprising:
a security medium; and
at least a partial coating, on the security medium, of polymer encapsulated metal particles.
